(19) United States
(12) Patent Application Publication
(10) Pub. No.: US 2021/0193099 A1
(43) Pub. Date: Jun. 24, 2021

(54) VIBRATION ABSORBING MATERIAL

(71) Applicant: 3M INNOVATIVE PROPERTIES COMPANY, St. Paul, MN (US)

(72) Inventor: Kohichiro Kawate, TOKYO (JP)

(21) Appl. No.: 17/051,873

(22) PCT Filed: Apr. 23, 2019
(86) PCT No.: PCT/IB2019/053349

§ 371 Date: Oct. 30, 2020

(30) Foreign Application Priority Data
May 1, 2018 (JP) 2018-088216

(51) Int. Cl. G10K 11/165; C08K 5/521; C08K 5/524; C08L 101/00; C08K 3/013; C08K 3/22

(52) U.S. Cl. CPC G10K 11/165; C08K 5/521; C08K 3/22; C08L 101/00; C08K 3/013; C08K 5/524

(57) ABSTRACT

An object of the present invention is to provide a vibration absorbing material having an improved followingness for an object to be applied and an improved convenience during use. The vibration absorbing material of the present invention is a pseudoplastic fluid comprising 40 parts by weight of a basic inorganic filler particle, a phosphate ester or a phosphite ester, and a binder.

### TECHNICAL FIELD

The present invention relates to a vibration absorbing material which is a pseudoplastic fluid, and to a method for applying the vibration absorbing material to an object.

### BACKGROUND ART

The phenomenon in which electronic parts such as a capacitor or an inductor occurs an abnormal noise by vibration when energized is well known. Further, even if the article itself does not create a vibration, the article may occur the abnormal noise by sympathetically vibrating with an external vibration. An example includes electronics loaded in a motor vehicle which is affected by the vibration of the motor vehicle. For example, when a wire harness vibrates, the problem such as loosening of its connector and degradation of solder bonding may be encountered in addition to the occurrence of an abnormal noise. Therefore, reducing the vibration is important in these articles.

In order to decrease the vibration in electronic parts, or in order to decrease the vibration or sound propagating to walls of building and the like, and in order to absorb the impact in sport goods or protective clothing, various vibration absorbing material has been conventionally used. The vibration absorbing material attenuates the mechanical vibration by converting it to heat energy. Currently widely known vibration absorbing material is usually composed of a polymer material. The common material changes the vibration into a heat by the friction between molecular chains, utilizing the properties that the molecular chain tends to return the original condition when the external force is removed while the conformation of the molecular chain is changed by external force.

For example, Patent Document 1 proposed a damping material composition obtained by containing a damping agent which is a phenol-based compound in an organic polymer matrix material. Patent Document 2 proposed a resin composition for a damping material comprising a thermoplastic resin having from 20 to 70 wt % of chlorine groups in the side chain and having a weight-average molecular weight of 400,000 or more and a chlorinated paraffin having a chlorine content of 30 to 75 wt % and having a carbon number of 12 to 50. Patent Document 3 proposed anti-vibration rubber composition containing polymers (A) to (C) as essential ingredients, each polymer having a different glass transition temperature or melting point, respectively.

### PRIOR ART DOCUMENTS

Patent Document 1: JP2004-149767A
Patent Document 2: JP2004-217694A
Patent Document 3: JP2005-179525A

### SUMMARY OF THE INVENTION

Conventional vibration absorbing materials is generally provided in a condition that has been previously formed in a sheet shape. However, such a vibration absorbing material is not necessarily excellent in terms of the followingness for an object to be applied and the convenience during use. For example, a material is desired that the material has fluidity during applying to an object, and that the material can be supplied by extruding from a container (i.e., has dispensability), while the material stably remains in place after applying to the object and the vibration energy is effectively attenuated.

### Means for Solving the Problem

The inventor found that a pseudoplastic fluid prepared by adding a phosphate ester or a phosphite ester and a binder to a basic inorganic filler particle is useful for the vibration absorbing material having a dispensability. The present invention encompasses the following embodiments.

(1) A vibration absorbing material which is a pseudoplastic fluid comprising 40 wt % or more of a basic inorganic filler particle, a phosphate ester or a phosphite ester, and a binder.

(2) The vibration absorbing material according to Item 1, wherein the vibration absorbing material has a storage modulus of 5,000 Pa or more over a temperature range of −30° C. to 90° C.

(3) The vibration absorbing material according to Item 1 or 2, wherein the vibration absorbing material has a tan δ of 1.0 or more as measured at a vibration frequency of 1 Hz over a temperature range of −30° C. to 90° C.

(4) The vibration absorbing material according to any of Items 1 to 3, comprising 0.05 wt % or more of the phosphate ester or the phosphite ester.

(5) The vibration absorbing material according to any of Items 1 to 4, wherein the binder has a viscosity of 100 mPa·s to 10,000 mPa·s at 25° C.

(6) The vibration absorbing material according to any of Items 1 to 5, wherein the vibration absorbing material has a stress of 5 Pa or more when the viscosity is 1,000 Pa·s or less at 25° C.

(7) The vibration absorbing material according to any of Items 1 to 6, wherein the binder comprises an oligomer having a weight-average molecular weight of 500 to 5,000.

(8) The vibration absorbing material according to any of Items 1 to 7, wherein the basic inorganic filler particle has an average particle size of 0.1 μm to 50 μm.

(9) The vibration absorbing material according to any of Items 1 to 8, wherein the particle size distribution of the basic inorganic filler particle is multimodal.

(10) The vibration absorbing material according to any of Items 1 to 9, wherein the basic inorganic filler particle comprises a metal oxide or a metal hydroxide.

(11) A method for applying a vibration absorbing material to an object, comprising the steps of preparing a dispenser accommodating the vibration absorbing material according to any of Items 1 to 10, and supplying the vibration absorbing material from the dispenser by applying a pressure in the vibration absorbing material.

### Effect of the Invention

According to the present invention, the vibration absorbing material can be provided having high convenience by extruding and supplying from a container and having an improved followingness to an object having various shapes. The vibration absorbing material of the present invention is useful in various application, including decreasing the vibration in electronic parts, decreasing the vibration or sound propagating to walls of building and the like, or absorbing the impact in sport goods or protective clothing.

### DESCRIPTION OF THE PREFERRED EMBODIMENTS

The vibration absorbing material of the present invention is characterized by a pseudoplastic fluid. The pseudoplastic fluid is a kind of a non-Newtonian fluid and has no yield value. The viscosity of the pseudoplastic fluid is decreased by applying a force. That is, the fluid is one that the coefficient of viscosity was decreased as the velocity gradient is increased. The vibration absorbing material of the present invention is a pseudoplastic fluid at a temperature of at least normal temperature (about 25° C.), in one embodiment, over a wide range of temperature, for example, at −30° C. or more, −20° C. or more, or −10° C. or more, and 90° C. or less, 80° C. or less, 70° C. or less, 60° C. or less, 50° C. or less, 40° C. or less, or 30° C. or less. Since the vibration absorbing material of the present invention is a pseudoplastic fluid, the material can be applied to the object by extruding from a dispenser, for example. The material has higher convenience than that of the conventional vibration absorbing material which is previously formed in a sheet shape. The vibration absorbing material of the present invention comprises a basic inorganic filler particle, a phosphate ester or a phosphite ester, and a binder. The vibration absorbing material of the present invention can be prepared by simply mixing a composition containing the basic inorganic filler particle, the phosphate ester or the phosphite ester, and the binder. The vibration absorbing material of the present invention can exert the vibration absorbing properties as it is, after applying to the object. Therefore, the vibration absorbing material of the present invention is not required curing or foaming by adding heat or irradiating ultraviolet ray or electron ray after applying to the object. The vibration absorbing material of the present invention can be directly applied to the object, and undercoating before applying is not required.

In one embodiment, the vibration absorbing material of the present invention has a tan δ (mechanical loss tangent) of 1.0 or more over a wide range of temperature, for example, at −30° C. or more, −20° C. or more, or −10° C. or more, and 90° C. or less, 80° C. or less, 70° C. or less, 60° C. or less, 50° C. or less, 40° C. or less, or 30° C. or less, as measured at a vibration frequency of 1 Hz. Preferably, in the range of temperature, tan δ is 13.0 or less, 12.0 or less, 11.0 or less, or 10.0 or less. A time-temperature conversion rule can be applied to the amount of tan δ. For example, tan δ over high frequency range having 1 Hz or more is known to correspond to tan δ at lower temperature than the measurement temperature. Therefore, in the vibration absorbing material of the present invention, tan δ of 1.0 or more means that tan δ is 1.0 or more within a wide range of frequencies when the temperature is constant, that is, the vibration absorbing properties is exerted within a wide range of frequencies. For example, the vibration absorbing material of the present invention may have tan δ of 1.0 or more within a range of 20 Hz or more, 500 Hz or more, or 1,000 Hz or more, and 10,000 Hz or less, 5,000 Hz or less, or 2,000 Hz or less at 25° C.

In one embodiment, the vibration absorbing material of the present invention has a storage modulus of 5,000 Pa or more, 7,500 Pa or more, 10,000 Pa or more, or 12,500 Pa or more over a wide range of temperature, for example, at −30° C. or more, −20° C. or more, or −10° C. or more, and 90° C. or less, 80° C. or less, 70° C. or less, 60° C. or less, 50° C. or less, 40° C. or less, or 30° C. or less, as measured at a vibration frequency of 1 Hz. The storage modulus refers to a stress required for deforming a material. Such an amount of the storage modulus means that the vibration absorbing material of the present invention maintains certain hardness within a wide range of temperatures, and for example, when the material was subjected to high temperature, the material does not melt and flow from the applied place by the external force.

The vibration absorbing material of the present invention is a pseudoplastic fluid as described above. In one embodiment, when the viscosity is measured while increasing the stress, the stress when the viscosity becomes 1,000 Pa·s or less is 5 Pa or more, in some cases, 10 Pa or more, 15 Pa or more, 20 Pa or more, 30 Pa or more, 40 Pa or more, or 50 Pa or more. Note that the phrase “the viscosity becomes 1,000 Pa·s or less” means that the material has a viscosity of 1,000 Pa·s or more when no stress is applied, and that the viscosity by a certain stress changes 1,000 Pa·s or less. Therefore, the case in which the viscosity has already been 1,000 Pa·s when no stress is applied is not within the meaning of the phrase. In a condition when the stress is low, for example, in a condition when the stress is below 1 Pa, the vibration absorbing material of the present invention may have a viscosity of 1,100 Pa·s or more, 1,200 Pa·s or more, or 1,300 Pa·s or more. Since the vibration absorbing material of the present invention has the physical properties as described above, for example, when the material was supplied by including in a dispenser, the material can be easily extruded from the container, and the material does not flow by weak external force such as gravity.

### (Basic Inorganic Filler Particle)

The vibration absorbing material of the present invention comprises 40 wt % or more, 45 wt % or more, 50 wt % or more, or 55 wt % or more of the basic inorganic filler particle. In one embodiment, the vibration absorbing material of the present invention may comprise 60 wt % or more, 65 wt % or more, 70 wt % or more, 75 wt % or more, 80 wt % or more, or 85 wt % or more of the basic inorganic filler particle. In one embodiment, the major ingredient of the vibration absorbing material of the present invention is the basic inorganic filler particle. As used herein, “wt %” means a ratio of the weight of the ingredient of interest to total weight of the composition (here, the total weight of the vibration absorbing material).

As used herein, “the inorganic filler particle is basic” means that a part of the particle surface, preferably all of the particle surface, shows the reactivity with an acid. An amphoteric compound having the reactivity with a base in addition to the reactivity with an acid is included in the meaning of the basicity in a broad sense. Preferably, the basic inorganic filler particle comprises a metal oxide, or a metal hydroxide, or both. In one embodiment, the basic inorganic filler particle consists of a metal oxide, a metal hydroxide, or a mixture thereof. Examples of the metal oxide included in the basic inorganic filler particle include aluminium oxide (Al₂O₃), magnesium oxide (MgO), zinc oxide (ZnO), and titanium oxide (TiO₂).) Examples of the metal hydroxide include aluminium hydroxide (Al(OH)₃), magnesium hydroxide (Mg(OH)₂), zinc hydroxide (Zn(OH)₂), and titanium hydroxide (Ti(OH)₄). Examples of the inorganic filler particle containing such a metal oxide of a metal hydroxide include natural mineral such as talc, mica, kaolin, and montmorillonite. Also, salts of an alkali metal or an alkaline earth metal such as calcium carbonate may be used as the basic inorganic filler particle.

The particle size of the basic inorganic filler particle is not particularly limited, as long as the vibration absorbing material prepared by the particle has properties of the pseudoplastic fluid. In one embodiment, the basic inorganic filler particle has an average primary particle size of 0.1 μm or more, 0.2 μm or more, 0.3 μm or more, or 0.4 μm or more, and 50 μm or less, 40 μm or less, 30 μm or less, or 20 μm or less as measured by an image analysis method. Although the basic inorganic filler particle may have a monomodal particle size distribution, when the particle has a dimodal, trimodal, or higher multimodal particle size distribution, the particle sometimes offer the properties of the pseudoplastic fluid to the vibration absorbing material. When the basic inorganic filler particle having an average particle size of the primary particle of 15 μm or more, 10 μm or more, 5 μm or more, or 3 μm or more is used, in particular, it may be preferred that the particle has a dimodal, trimodal, or higher multimodal particle size distribution by using the particle with the particle having a smaller average particle size.

### (Phosphate Ester or Phosphite Ester)

The vibration absorbing material of the present invention comprises at least one of the phosphate ester or the phosphite ester. Without limited by the theory, it is believed that the phosphate ester or the phosphite ester forms a network between filler particles by interacting with the surface of the basic inorganic filler particle, and they contribute to offer the properties of the pseudoplastic fluid, that is, the viscosity is high when the applied stress is weak. The vibration absorbing material of the present invention may comprise the phosphate ester or the phosphite ester in amount of 0.05 wt % or more, 0.06 wt % or more, or 0.07 wt % or more. In preferred embodiment, the phosphate ester or the phosphite ester may be included in an amount of 0.1 wt % or more, 0.2 wt % or more, or 0.3 wt % or more. The amount of the phosphate ester or the phosphite ester is not limited, as long as the properties of the vibration absorbing material as the pseudoplastic fluid is not disturbed. In one embodiment, the amount of the phosphate ester or the phosphite ester is 5 wt % or less, 4 wt % or less, 3 wt % or less, 2 wt % or less, or 1.8 wt % or less.

In one embodiment, the phosphate ester is a compound represented by the following formula (I), and the phosphite ester is a compound represented by the following formula (II).

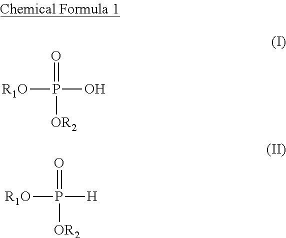

In the formula (I) or the formula (II), R₁ and R₂ may be identical or different substituent group. In one embodiment, R₁ and R₂ are each independently an aliphatic, an alicyclic, or an aromatic hydrocarbon group having a carbon number of 1 to 36, 1 to 24, or 1 to 18, which may be interposed by hydrogen, or one to three hetero atom/atoms selected from O, N, or S, or an ester bond or an amide bond. However, there is no case that R₁ and R₂ are both hydrogen at the same time. R In one embodiment, R₁ and R₂ may be each independently hydrogen, a methyl group, an ethyl group, a propyl group, a butyl group, a butoxyethyl group, a hexyl group, an ethylhexyl group, a dodecyl group, a lauryl group, a tridecyl group, a tetradecyl group, a hexadecyl group, an oleyl group, a stearyl group, or a phenyl group.

When the phosphate ester or the phosphite ester is used for a member which is contacted with an electrical device, the phosphate ester or the phosphite ester is known to corrode the surrounding parts due to the breeding. For example, in a heat conducting material, even if the phosphate ester or the phosphite ester is required to use, very small amount of the ester is desirably used. However, since the vibration absorbing material of the present invention is the pseudoplastic fluid, the risk of breeding is believed to be lower than the material which was formed in a sheet shape. Therefore, necessity of limiting the content of the phosphate ester or the phosphite ester is low in terms of preventing corrosion.

### (Binder)

The vibration absorbing material of the present invention comprises a binder in addition to the basic inorganic filler particle and the phosphate ester or the phosphite ester. In the vibration absorbing material of the present invention, the binder is believed to contribute to offer the properties of the pseudoplastic fluid to the vibration absorbing material by playing a role as a lubricant between filler particles. In one embodiment, the binder is a viscous fluid, and has a viscosity at 25° C. of 100 mPa·s or more, 200 mPa·s or more, 300 mPa·s or more, 400 mPa·s or more, or 500 mPa·s or more, and 10,000 mPa·s or less, 9,000 mPa·s or less, 8,000 mPa·s or less, 7,000 mPa·s or less, 6,000 mPa·s or less, or 5,000 mPa·s or less. The binder may be a Newtonian fluid or a non-Newtonian fluid.

An example of the binder includes a liquid oligomer. As used herein, the “oligomer” refers to a polymer product having a monomer unit repeats of about 10 or more and about 100 or less, or having a weight-average molecular weight of 5,000 or less, 4,000 or less, or 3,000 or less, preferably 500 or more. The binder comprises such an oligomer. In one embodiment, the binder consists of such an oligomer only. Specific examples of the binder include a (meth)acrylate oligomer and an urethane acrylate. When the oligomer included in the binder has an acid functional group such as a carboxylic group, it is advantageous that the oligomer offers the properties of the pseudoplastic fluid to the vibration absorbing material of the present invention by interacting with the basic inorganic filler particle. The oligomer included in the binder can be used as it is in the vibration absorbing material of the present invention. Before or after mixing with the other ingredients, the oligomer is not required to further polymerize or crosslink with heat and ultraviolet ray or electron ray. However, if needed, the oligomer may be further polymerize or crosslink after mixing with the other ingredients.

### (Additional Ingredient)

The vibration absorbing material of the present invention may comprise any other ingredient in addition to one as described above, as long as the properties of the pseudoplastic fluid is not disturbed. Examples of the ingredient include fillers such as an anti-rust agent, a thermal conductor, a flame retardant, a polymer bead, and a glass bead.

### (Method for Applying Vibration Absorbing Material)

In another aspect, the present invention relates to a method for applying the vibration absorbing material as described above to an object. The method for applying a vibration absorbing material of the present invention comprises at least steps of preparing a dispenser accommodating the vibration absorbing material, and supplying the vibration absorbing material from the dispenser by applying a pressure in the vibration absorbing material. As a dispenser, any known dispenser such as a syringe type or a tube type can be used. A method for applying a pressure to such a dispenser is also known.

### EXAMPLES

The present invention will be described more specifically below using examples, but the present invention is not intended to be limited to the examples.

### (Evaluation Method)

### Dynamic Viscoelasticity Measurement:

ARES viscoelasticity measurement system (RSA-III, Rheometrics Scientific F.E. Ltd.) was used. A sample having a thickness of 2 mm was sandwiched between two parallel disks having a diameter of 15 mm. The mechanical loss tangent (tan δ) and the storage modulus of the sample was measured within a temperature range of −10° C. to 30° C. (in some example, −10° C. to 90° C.) and at 1 Hz when 0.2% of strain was applied.

### Viscosity Measurement:

A reometer (HAAKE, using RheoWin Pro software) was used. A sample having a thickness of 0.052 mm was sandwiched between a cone having a diameter of 20 mm (angle: 1°) and a plate jig. The rotational viscosity of the sample was measured while increasing the shear stress from 0 Pa to 10,000 Pa.

### Creep Resistance Measurement:

A sample was applied at an area of 20×20 mm so that the thickness becomes 1 mm at a surface of a steel plate washed with MEK (JIS G3144 (SPCC-SD). The steel plate kept standing in a oven at 85° C. for 24 hours, and then whether the sample was flowing or not was confirmed.

### Dispensability:

When an air pressure of 0.3 MPa was applied to a sample filled in a 30 mL syringe for 5 sec, the dispensability was determined by testing whether 0.1 cm³ or more of the sample can be extruded or not.

### (Preparation of Samples)

Materials shown in Table 1 were mixed according to the formulation shown in Table 2. The composition of Examples 1 to 12 and Comparative Examples 1 to 3 were prepared by agitating the mixture by a hybrid mixer (HM-500, KEYENCE CORPORATION) for 5 min.

Used materials:

| | |
|---|---|
| (meth)acrylate | ARUFON UC3510 (Mw = 2000, AV = 70 |
| oligomer A | mgKOH/g, viscosity: 5000 mPa · s at 25° C., |
| | TOAGOSEI CO., LTD.) |
| (meth)acrylate | ARUFON UP1020 (Mw = 2000, viscosity: |
| oligomer B | 500 mPa · s at 25° C., TOAGOSEI CO., LTD.) |
| phosphate ester C | JP-518-O (oreyl acid phosphate, JOHOKU |
| | CHEMICAL CO., LTD) |
| phosphate ester D | JP-508 (2-ethylene hexyl acid phosphate, |
| | JOHOKU CHEMICAL CO., LTD) |
| phosphate ester E | JP-506H (butoxyethyl acid phosphate, |
| | JOHOKU CHEMICAL CO., LTD) |
| phosphate ester F | JAMP-4 (mono n-butyl phosphate, JOHOKU |
| | CHEMICAL CO., LTD) |
| phosphite ester G | JPE-208 (bis(2-ethylhexyl)hydrogen phosphite, |
| | JOHOKU CHEMICAL CO., LTD) |
| aluminium oxide | AA-18 (primary particle size (SEM) = 18 μm, |
| filler H | Sumitomo Chemical Co., Ltd.) |
| aluminium oxide | AA-1.5 (primary particle size (SEM) = 1.5 μm, |
| filler I | Sumitomo Chemical Co., Ltd.) |
| aluminium oxide | AA-04 (primary particle size (SEM) = 0.4 μm, |
| filler J | Sumitomo Chemical Co., Ltd.) |
| aluminium | B53 (average particle size: 55 μm, Nippon |
| hydroxide filler K | Light Metal Co., Ltd.) |
| aluminium | BF083 (average particle size: 10 μm, Nippon |
| hydroxide filler L | Light Metal Co., Ltd.) |
| aluminium | BF013 (average particle size: 1 μm, Nippon |
| hydroxide filler M | Light Metal Co., Ltd.) |

TABLE 2
Formulation:

| | Example | Example | Example | Example | Example | Example | Example | Comparative |
|---|---|---|---|---|---|---|---|---|
| | 1 | 2 | 3 | 4 | 5 | 6 | 7 | Example 1 |
| meth)acrylate | 400 | 400 | 400 | 400 | 400 | 0 | 400 | 400 |
| oligomer A | | | | | | | | |
| meth)acrylate | 0 | 0 | 0 | 0 | 0 | 400 | 0 | 0 |
| oligomer B | | | | | | | | |
| phosphate ester C | 10 | 0 | 0 | 0 | 0 | 10 | 10 | 0 |
| phosphate ester D | 0 | 10 | 0 | 0 | 0 | 0 | 0 | 0 |
| phosphate ester E | 0 | 0 | 10 | 0 | 0 | 0 | 0 | 0 |
| phosphate ester F | 0 | 0 | 0 | 10 | 0 | 0 | 0 | 0 |
| phosphite ester G | 0 | 0 | 0 | 0 | 10 | 0 | 0 | 0 |
| aluminium oxide | 1800 | 1800 | 1800 | 1800 | 1800 | 1800 | 0 | 1800 |
| filler H | | | | | | | | |
| aluminium oxide | 500 | 500 | 500 | 500 | 500 | 500 | 0 | 500 |
| filler I | | | | | | | | |
| aluminium oxide | 60 | 60 | 60 | 60 | 60 | 60 | 0 | 60 |
| filler J | | | | | | | | |
| aluminium hydroxide | 0 | 0 | 0 | 0 | 0 | 0 | 600 | 0 |
| filler K | | | | | | | | |
| aluminium hydroxide | 0 | 0 | 0 | 0 | 0 | 0 | 800 | 0 |
| filler L | | | | | | | | |
| aluminium hydroxide | 0 | 0 | 0 | 0 | 0 | 0 | 400 | 0 |
| filler M | | | | | | | | |
| average particle | 12.0 μm | 12.0 μm | 12.0 μm | 12.0 μm | 12.0 μm | 12.0 μm | 23.0 μm | 12.0 μm |
| size of total | | | | | | | | |
| fillers (μm) | | | | | | | | |

| | Example | Example | Comparative | Example | Example | Example | Comparative |
|---|---|---|---|---|---|---|---|
| | 8 | 9 | Example 2 | 10 | 11 | 12 | Example 3 |
| (meth)acrylate oligomer A | 400 | 400 | 400 | 400 | 400 | 0 | 400 |
| (meth)acrylate oligomer B | 0 | 0 | 0 | 0 | 0 | 400 | 0 |
| phosphate ester C | 2 | 50 | 10 | 10 | 10 | 10 | 10 |
| aluminium oxide filler H | 1800 | 1800 | 1800 | 0 | 0 | 0 | 0 |
| aluminium oxide filler I | 500 | 500 | 0 | 1000 | 0 | 500 | 0 |
| aluminium oxide filler J | 60 | 60 | 0 | 0 | 500 | 0 | 200 |
| average particle size of | 12.0 μm | 12.0 μm | 18.0 μm | 1.5 μm | 0.4 μm | 1.5 μm | 0.4 μm |
| total fillers (μm) | | | | | | | |

(Unit: parts by weight)

### (Evaluation Results)

The measurement results of the mechanical loss tangent (tan δ), the storage modulus, and the viscosity is shown in Tables 3 to 5, respectively. Evaluation results of creep resistance measurement and dispensability are shown in Table 6.

TABLE 3
mechanical loss tangent tanδ (1 Hz), temperature range: −10° C.-30° C.

| | Example | Example | Example | Example | Example | Example | Example | Comparative |
|---|---|---|---|---|---|---|---|---|
| temperature | 1 | 2 | 3 | 4 | 5 | 6 | 7 | Example 1 |
| −10° C. | 3.40 | 2.30 | 1.80 | 1.70 | 2.20 | 1.50 | 1.40 | 7.30 |
| 0° C. | 3.30 | 5.50 | 2.60 | 3.20 | 4.10 | 1.40 | 1.90 | 14.00 |
| 10° C. | 2.50 | 5.80 | 1.80 | 4.70 | 4.90 | 1.40 | 1.70 | 19.00 |
| 20° C. | 1.80 | 4.20 | 1.40 | 3.90 | 3.80 | 1.70 | 1.20 | 16.00 |
| 30° C. | 1.40 | 2.40 | 1.10 | 2.70 | 2.70 | 1.60 | 1.10 | 17.00 |

| | Example | Example | Comparative | Example | Example | Example | Comparative |
|---|---|---|---|---|---|---|---|
| temperature | 8 | 9 | Example 2 | 10 | 11 | 12 | Example 3 |
| −10° C. | 5.10 | 1.50 | 2.50 | 1.90 | 1.30 | 1.80 | 6.40 |
| 0° C. | 6.50 | 1.60 | 5.00 | 1.90 | 1.30 | 2.00 | 19.00 |
| 10° C. | 5.00 | 1.50 | 7.20 | 1.90 | 1.40 | 2.10 | 23.00 |
| 20° C. | 3.50 | 1.40 | 5.90 | 1.60 | 1.20 | 1.80 | 22.00 |
| 30° C. | 2.50 | 1.30 | 8.20 | 1.40 | 1.00 | 1.40 | 26.00 |

mechanical loss tangent tanδ (1 Hz), temperature range: −10° C.-90° C.

| Temperature | −10° C. | 0° C. | 10° C. | 20° C. | 30° C. | 40° C. | 50° C. | 60° C. | 70° C. | 80° C. | 90° C. |
|---|---|---|---|---|---|---|---|---|---|---|---|
| Example 5 | 2.20 | 4.10 | 4.90 | 3.80 | 2.70 | 2.00 | 1.60 | 1.40 | 1.30 | 1.20 | 1.10 |
| Example 8 | 5.10 | 6.50 | 5.00 | 3.50 | 2.50 | 2.00 | 1.80 | 1.60 | 1.50 | 1.40 | 1.30 |

TABLE 4
storage modulus, temperature range: 10° C.-30° C.

| | Example | Example | Example | Example | Example | Example | Example | Comparative |
|---|---|---|---|---|---|---|---|---|
| temperature | 1 | 2 | 3 | 4 | 5 | 6 | 7 | Example 1 |
| −10° C. | 210,000 | 65,000 | 120,000 | 51,000 | 44,000 | 43,000 | 200,000 | 3,800 |
| 0° C. | 230,000 | 52,000 | 150,000 | 63,000 | 45,000 | 62,000 | 270,000 | 4,300 |
| 10° C. | 200,000 | 43,000 | 220,000 | 39,000 | 31,000 | 59,000 | 330,000 | 2,500 |
| 20° C. | 180,000 | 37,000 | 220,000 | 30,000 | 25,000 | 36,000 | 440,000 | 1,600 |
| 30° C. | 150,000 | 44,000 | 220,000 | 25,000 | 21,000 | 29,000 | 380,000 | 630 |

| | Example | Example | Comparative | Example | Example | Example | Comparative |
|---|---|---|---|---|---|---|---|
| temperature | 8 | 9 | Example 2 | 10 | 11 | 12 | Example 3 |
| −10° C. | 89,000 | 120,000 | 12,000 | 140,000 | 340,000 | 30,000 | 370 |
| 0° C. | 89,000 | 170,000 | 12,000 | 220,000 | 610,000 | 45,000 | 420 |
| 10° C. | 81,000 | 180,000 | 6,900 | 220,000 | 550,000 | 38,000 | 310 |
| 20° C. | 71,000 | 170,000 | 4,400 | 200,000 | 440,000 | 28,000 | 170 |
| 30° C. | 62,000 | 160,000 | 1,300 | 170,000 | 370,000 | 27,000 | 60 |

storage modulus, temperature range: 10° C.-90° C.

| temperature | −10° C. | 0° C. | 10° C. | 20° C. | 30° C. | 40° C. | 50° C. | 60° C. | 70° C. | 80° C. | 90° C. |
|---|---|---|---|---|---|---|---|---|---|---|---|
| Example 5 | 44000 | 45000 | 31000 | 25000 | 21000 | 19000 | 18000 | 18000 | 19000 | 20000 | 23000 |
| Example 8 | 89000 | 89000 | 81000 | 71000 | 62000 | 51000 | 46000 | 42000 | 40000 | 39000 | 39000 |

(Unit: Pa)

TABLE 5
viscosity:

| | Example | Example | Example | Example | Example | Example | Example | Comparative |
|---|---|---|---|---|---|---|---|---|
| | 1 | 2 | 3 | 4 | 5 | 6 | 7 | Example 1 |
| @10 Pa | 1,600 | 1,480 | 5,990 | 1,900 | 1,340 | 10,730 | 2,500,000 | 391 |
| @100 Pa | 160 | 230 | 300 | 320 | 230 | 8 | 445 | 451 |
| stress when the | 64 Pa | 79 Pa | 288 Pa | 151 Pa | 46 Pa | 22 Pa | 2,220 Pa | not present |
| viscosity | | | | | | | | |
| becomes 1,000 | | | | | | | | |
| Pa or less | | | | | | | | |

| | Example | Example | Comparative | Example | Example | Example | Comparative |
|---|---|---|---|---|---|---|---|
| | 8 | 9 | Example 2 | 10 | 11 | 12 | Example 3 |
| @10 Pa | 1,526 | 3,605 | 2,578 | 4,841 | 14,950 | 650 | 14 |
| @100 Pa | 920 | 654 | 601 | 950 | 2085 | 68 | 13 |
| stress when the | 79 Pa | 88 Pa | 71 Pa | 88 Pa | 151 Pa | 6.7 Pa | not present |
| viscosity becomes | | | | | | | |
| 1,000 Pa or less | | | | | | | |
| (Pa) | | | | | | | |

(Unit: Pa · s)

TABLE 6

| | Example | Example | Example | Example | Example | Example | Example | Comparative |
|---|---|---|---|---|---|---|---|---|
| | 1 | 2 | 3 | 4 | 5 | 6 | 7 | Example 1 |
| creep | Pass | Pass | Pass | Pass | Pass | Pass | Pass | Fail |
| resistance | | | | | | | | |
| dispensability | Pass | Pass | Pass | Pass | Pass | Pass | Pass | Pass |

| | Example | Example | Comparative | Example | Example | Example | Comparative |
|---|---|---|---|---|---|---|---|
| | 8 | 9 | Example 2 | 10 | 11 | 12 | Example 3 |
| creep | Pass | Pass | Fail | Pass | Pass | Pass | Fail |
| resistance | | | | | | | |
| dispensability | Pass | Pass | Pass | Pass | Pass | Pass | Pass |

### (Acoustic Wave Evaluation)

Six adhesive tapes (100 mm×3 mm×0.3 mm) were evenly adhered to an aluminium plate (100 mm×100 mm×1 mm). The composition of Example 1 was applied to five areas between adhesive tapes. After that, an aluminium plate having the same size was stacked to the plate to produce a sample. As a control, a sample was prepared in a similar way as in Example 1, except that the composition of Example 1 was not applied. A commercially available buzzer was fixed on the surface of each of the resulting sample. When a sound was generated from the buzzer, the vibration was measured with a software (SpectrumView, Oxford Wave Research Ltd.). A noise having a frequency of 3 kHz or less was observed in the control sample using the adhesive tape only, while a noise having a frequency of 3 kHz or less was entirely lost in the sample using the composition of Example 1. Further, for the sample using the composition of Example 1, it could confirm that the noize within a frequency range of 3 to 6 kHz is decreased.

1. A vibration absorbing material which is a pseudoplastic fluid comprising 40 wt % or more of a basic inorganic filler particle, a phosphate ester or a phosphite ester, and a binder.

2. The vibration absorbing material according to claim 1, wherein the vibration absorbing material has a storage modulus of 5,000 Pa or more over a temperature range of −30° C. to 90° C.

3. The vibration absorbing material according to claim 1, wherein the vibration absorbing material has a tan δ of 1.0 or more as measured at a vibration frequency of 1 Hz over a temperature range of −30° C. to 90° C.

4. The vibration absorbing material according to claim 1, comprising 0.05 wt % or more of the phosphate ester or the phosphite ester.

5. The vibration absorbing material according to claim 1, wherein the binder has a viscosity of 100 mPa·s to 10,000 mPa·s at 25° C.

6. The vibration absorbing material according to claim 1, wherein the vibration absorbing material has a stress of 5 Pa or more when the viscosity is 1,000 Pa·s or less at 25° C.

7. The vibration absorbing material according to claim 1, wherein the binder comprises an oligomer having a weight-average molecular weight of 500 to 5,000.

8. The vibration absorbing material according to claim 1, wherein the basic inorganic filler particle has an average particle size of 0.1 μm to 50 μm.

9. The vibration absorbing material according to claim 1, wherein the particle size distribution of the basic inorganic filler particle is multimodal.

10. The vibration absorbing material according to claim 1, wherein the basic inorganic filler particle comprises a metal oxide or a metal hydroxide.

11. A method for applying a vibration absorbing material to an object, comprising the steps of preparing a dispenser accommodating the vibration absorbing material according to claim 1, and supplying the vibration absorbing material from the dispenser by applying a pressure in the vibration absorbing material.
